(19) United States
(12) Patent Application Publication
(10) Pub. No.: US 2008/0195498 A1
(43) Pub. Date: Aug. 14, 2008

(54) WIRELESS NETWORK SYSTEMS HAVING ACCESSIBILITY BASED ON USAGE OF AN ACCOUNT

(75) Inventors: Erik S. Crawford, Parker, CO (US); Thomas B. Sayor, Castle Rock, CO (US); Ken Algiene, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First DAta Corporation, Greenwood Village, CO (US)

(21) Appl. No.: 12/022,941

(22) Filed: Jan. 30, 2008

Related U.S. Application Data
(63) Continuation-in-part of application No. 10/953,863, filed on Sep. 28, 2004.

(51) Int. Cl. G06Q 20/00; G06Q 10/00

(52) U.S. Cl. 705/21; 705/30

(57) ABSTRACT

Systems and methods for providing connectivity to a wireless network may include a point of sale device at a merchant location that is used to receive an account identifier that in turn is associated with a stored value account of a customer. The account identifier is transmitted along with transaction data to a financial network to permit the stored value account to be processed according to the transaction request. When needing to receive wireless access, a customer using a personal communications device transmits a request to obtain wireless access while he is at the merchant location. An evaluation is performed to confirm that the customer has performed a transaction involving the stored value account within a certain time period. Wireless access to the wireless network is provided if the customer has performed the transaction within the certain time period.

### CROSS-REFERENCES TO RELATED APPLICATIONS

This application in a continuation in part application and claims the benefit of copending U.S. application Ser. No. 10/953,863, filed Sep. 28, 2004, the complete disclosure of which is herein incorporated by reference.

This application is also related to co-pending, commonly assigned U.S. patent application Ser. No. 10/675,924, entitled “ACTIVATING TELEPHONE-BASED SERVICES USING A POS DEVICE,” filed on Sep. 29, 2003 by Christopher R. McGee, the entire disclosure of which is herein incorporated for all purposes.

### BACKGROUND OF THE INVENTION

Wireless network access is becoming increasingly common at merchant locations and public facilities. Many coffee shops, book stores, libraries, airports, and the like, provide wireless network access to their customers and/or facility users. Anyone with a laptop or hand held computer, personal digital assistant, or the like can have Internet access by completing a registration process that establishes communication between their device and the wireless network. Sometimes, however, the registration process may be intrusive.

Especially where access is not free, network users must provide extremely personal information to obtain access to such services. Many users are not comfortable providing credit card numbers, and the like to open networks. Others desire complete anonymity with respect to their activities on the Internet. Further, merchants desire to increase their customer loyalty and the profits they derive from providing services such as wireless network access to their customers. Thus, systems and methods are needed that improve the process by which customers access wireless networks at merchant locations and public facilities.

### BRIEF SUMMARY OF THE INVENTION

The invention provides various systems and methods for providing connectivity to a wireless network. In one exemplary method, a point of sale device at a merchant location is used to receive an account identifier that is associated with a stored value account of a customer. The account identifier is transmitted along with transaction data to a financial network to permit the stored value account to be processed according to the transaction request. When needing to receive wireless access, a customer using a personal communications device transmits a request to obtain wireless access while he is at the merchant location. An evaluation is performed to confirm that the customer has performed a transaction involving the stored value account within a certain time period. Wireless access to the wireless network is provided if the customer has performed the transaction within the certain time period.

According to one aspect, the identifier comprises an account number that is associated with the stored value account. In some cases, the account number may be obtained from a stored value presentation instrument held by the customer. Alternatively, the identifier may comprise a transaction number that is provided to the customer at the time of a transaction. For example, a point of sale device may print a receipt having a transaction number or other identifier.

In one aspect, the merchant location includes a local network having a merchant host computer system which includes a web server computer. Also, the web server computer comprises the wireless communications device. The web server computer receives transaction data from the merchant host computer system or a remote stored value host computer system, and the transaction data is compared with the account number to determine whether the customer has performed the transaction within the certain time period.

In an alternative arrangement, the merchant location includes a router which communicates with a wireless network host computer system. Also, the wireless network host computer system comprises the wireless communications device. The wireless network host computer system receives transaction data from a merchant host computer system or a remote stored value host computer system, and the transaction data is compared with the account number to determine whether the customer has performed the transaction within the certain time period.

In a further alternative aspect, the web server computer receives the transaction number from the merchant host computer system, and the transaction identifier from the customer is compared with the identifier from the merchant host computer system to determine whether the customer has performed the transaction within the certain time period. In yet another alternative, the wireless network host computer system receives the transaction number from a merchant host computer system, and the transaction identifier from the customer is compared with the identifier from the merchant host computer system to determine whether the customer has performed the transaction within the certain time period.

According to one particular arrangement, the certain time is within the last twenty-four hours and wireless access is provided to the wireless network for a time that is in the range from about 2 hours to about 4 hours. In one aspect, a connectivity time to the wireless network may be based on a value of the transaction. Also, the transaction may be any one of a variety of transactions, such as redemptions, reloads, activations and balance inquiries.

In a further embodiment, the invention provides a system for providing access to a wireless network. The system comprises a wireless communications device that is configured to receive a request to provide access to the wireless network. The request originates from a personal computing device of a customer who is present at a merchant location. Also, the request includes an identifier provided to the customer. The wireless communications device is configured to evaluate the identifier to determine whether the customer has performed a transaction at the merchant location using a stored value account of the customer within a certain time period. If so, wireless access is provided to the wireless network.

To gain access, the customer may use a personal computing device having a wireless transceiver device to transmit the identifier to the wireless communications device. In one aspect, the identifier may comprise an account number that is associated with the stored value account.

The system may also include a local network that is disposed at the merchant location. The local network may comprise a merchant host computer system which includes a web server computer. In some cases, the web server computer may comprise the wireless communications device. In one aspect, the web server computer is configured to receive transaction data from the merchant host computer system and to compare the transaction data with the account number to determine whether the customer has performed the transaction within the certain time period.

In one particular aspect, the system includes a remote stored value host computer system. In such cases, the web server computer may be configured to receive transaction data from the stored value host computer system. Also, the web server computer may be configured to compare the transaction data with the account number to determine whether the customer has performed the transaction within the certain time period.

In a further aspect, the merchant location includes a router which communicates with a wireless network host computer system. In such cases, the wireless network host computer system may comprise the wireless communications device. In this arrangement, the wireless network host computer system may be configured to receive transaction data from a merchant host computer system. The transaction data is compared with the account number to determine whether the customer has performed the transaction within the certain time period. The wireless network host computer system may be configured to receive transaction data from a remote stored value host computer system. The transaction data is compared with the account number to determine whether the customer has performed the transaction within the certain time period.

The system may also include a point of sale device. Further, the identifier may comprise a transaction number that was provided to the customer by the point of sale device after performing a transaction involving the stored value account at the merchant location.

In one particular arrangement, the merchant location may include a local network having a merchant host computer system which includes a web server computer and a point of sale device. The web server computer may comprise the wireless communications device. In this way, the web server computer may be configured to receive the transaction number from the merchant host computer system. The transaction identifier from the customer may be compared with the identifier from the merchant host computer system to determine whether the customer has performed the transaction within the certain time period. In one arrangement, the merchant location may include a router which communicates with a wireless network host computer system. In such cases, the wireless network host computer system may comprise the wireless communications device. The wireless network host computer system may be configured to receive the transaction number from a merchant host computer system. The transaction identifier from the customer is compared with the identifier from the merchant host computer system to determine whether the customer has performed the transaction within the certain time period.

Some embodiments of the invention provide a method of providing network access. The method includes entering network access information into a merchant device at a merchant location. The information relates to a request from a customer to obtain network access. The method also includes causing the information to be transmitted to a host computer system from the merchant device, receiving a payment from the customer, receiving activation confirmation from the host computer system at the merchant device, and providing a presentation instrument to the customer. The presentation instrument may be used by the customer to obtain network access. The method further includes using the presentation instrument to settle a transaction with the customer for merchandise.

In some embodiments, the merchant location may be a retail store, restaurant, airport, library, fast food establishment, coffee shop, bank, mall, office building, sports arena, apartment complex, airplane, automobile, hotel, e-commerce site, health club, and/or the like. The merchant device may be a point-of-sale device, automated teller machine, kiosk, e-commerce server, vending machine, and/or the like. The network access may relate to a wireless network operated from within the merchant location. The wireless network may be a Wireless Fidelity (WiFi) network, WiMAX network, 802.11a network, 802.11g network, 802.16 network, 3G network. The merchant device may be a point-of-sale device having a reader. Entering network access information into a merchant device may include using the reader to obtain information from the presentation instrument. The reader may be a magnetic stripe reader, bar code reader, RFID reader, infrared reader, and/or the like. Receiving activation confirmation from the host computer system may include receiving an activation key code from the host computer system. The presentation instrument may be a card having a magnetic stripe, a card having a smart chip, a radio frequency emitting device, a virtual card, a “key chain” card, an infrared device, and/or the like. The presentation instrument may include a scratch-off, password-revealing area. Using the presentation instrument to settle a transaction with the customer for merchandise may include selling food or beverage to the customer.

In further embodiments, a system for providing network access includes a host computing system in communication with at least one merchant device. The host computing system is configured to receive a request from the merchant device to activate a network access presentation instrument for a customer, verify the validity of the presentation instrument, return an activation confirmation message to the merchant device, receive a request from a computing device of the customer to access a network, determine whether to allow the customer to access the network based on a network access account balance relating to the presentation instrument, and process a transaction for merchandise purchased by the customer using the presentation instrument. The network access may relate to a wireless network operated from within a merchant location.

In still further embodiments, the host computer system may be further configured to receive a request from the customer to convert loyalty value to network access value, increase the network access account balance, and decrease the loyalty account balance by a factor corresponding to an amount by which the network access account balance is increased.

In additional embodiments, a method of providing network access includes receiving a request from a merchant device to activate a network access presentation instrument for a customer, verifying the validity of the presentation instrument, returning an activation confirmation message to the merchant device, receiving a request from a computing device of the customer to access a network, determining whether to allow the customer to access the network based on an account balance relating to the presentation instrument, and processing a transaction for merchandise purchased by the customer using the presentation instrument. The method may include receiving a request from the customer to convert loyalty value to network access value, increasing the network access account balance, and decreasing the loyalty account balance by a factor corresponding to an amount by which the network access account balance is increased.

In other embodiments a method of providing wireless network access includes entering network access information into a merchant device at a merchant location. The information relates to a request from a customer to obtain network access to a wireless network. The method includes causing the information to be transmitted to a host computer system from the merchant device, receiving a payment from the customer, receiving activation confirmation from the host computer system at the merchant device, and providing a presentation instrument to the customer. The presentation instrument may be used by the customer to obtain network access. The method may include using the presentation instrument to settle a transaction for goods or services with the customer. The method may include receiving a request from the customer to add value to the presentation instrument, receiving payment from the customer for the additional value, and adding the value to the presentation instrument. The presentation instrument may be a virtual presentation instrument.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a system for providing access according to embodiment of the invention.

FIG. 2 illustrates an exemplary presentation instrument that may be used to access a network according to embodiments of the invention.

FIG. 3 illustrates a method of activating a network access presentation instrument according to embodiments of the invention.

FIG. 4 illustrates a method of providing network access according to embodiments of the invention.

FIG. 5 illustrates an exemplary network access display screen.

FIG. 6 illustrates an exemplary account maintenance display screen.

FIG. 7 illustrates a further embodiment of a system of providing wireless access to a network.

FIG. 8 is a flowchart illustrating an exemplary method for providing wireless access to a network.

### DETAILED DESCRIPTION OF THE INVENTION

According to embodiments of the invention, merchants and other network access providers provide customers with access to wireless networks through prepaid presentation instruments. Such presentation instruments include cards, fobs, mini-cards, “virtual” presentation instruments, and the like. In some embodiments, the presentation instrument includes an information encoding area, capable of being read by a reader, that may be used to activate the presentation instrument and/or to log on to wireless networks. In some embodiments, the presentation instrument also may be used for purchases from merchants. In some embodiments, use of the presentation instrument may be combined with customer loyalty programs. For example, if a customer purchases merchandise, food, beverages, and/or services from the merchant, the customer may qualify for free or reduced rate network access.

The present invention is not limited to obtaining network access from merchants. In some embodiments, public facilities, such as airports and libraries, provide network access using similar or identical systems and methods. Further, in some embodiments, many merchants may cooperate to offer integrated services to their customers. Further still, in some embodiments, a wireless network access service provider may provide such service through a number of merchant locations and/or public facilities. Those skilled in the art will appreciate additional embodiments and equivalents in light of the disclosure herein.

Network access may be provided in a variety of ways. For example, access may be provided simply by using the prepaid instrument at the merchant location, such as when the prepaid instrument is read by a point of sale device. In other cases, access may be provided by debiting a value from the prepaid account. Hence, in some cases, wireless access is free to the consumer (simply by using the instrument to make a purchase). In other cases, the stored value account is debited for the usage.

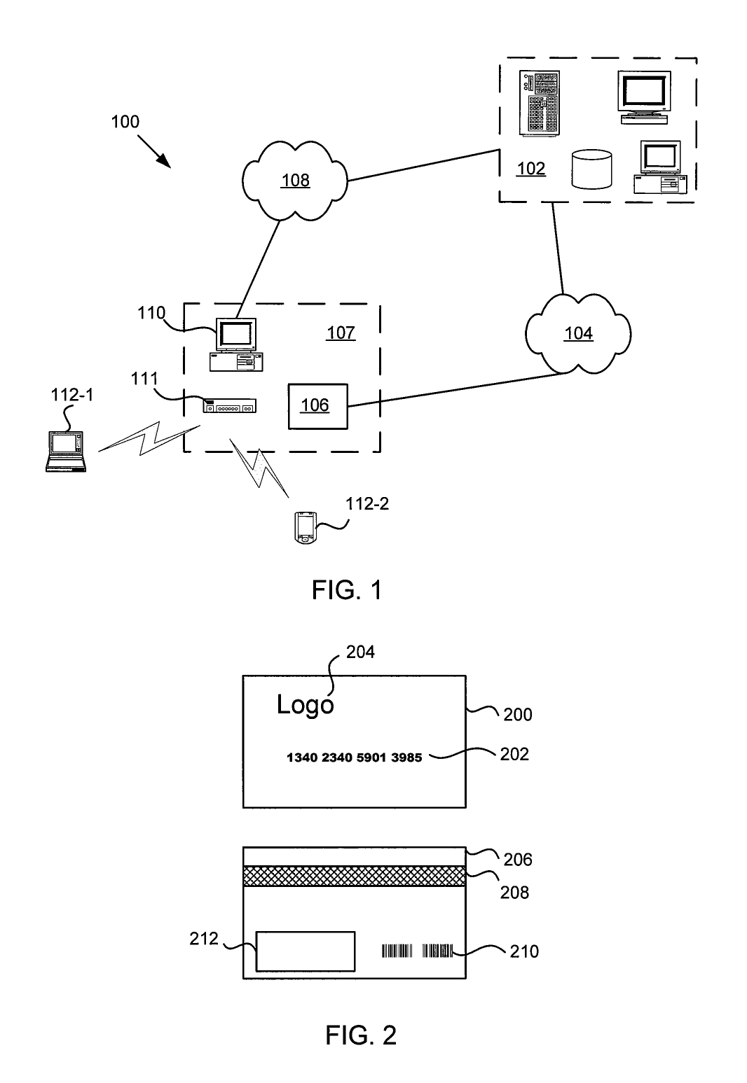

Having described the present invention generally, attention is directed to FIG. 1, which illustrates one exemplary embodiment of a system 100 according to the present invention. As will be explained in more detail hereinafter, the system 100 may be used to provide prepaid wireless network access. It should be understood that the examples used herein relate to accessing packet-based networks such as the Internet. However, this is not a requirement. The teachings herein may be applied to accessing other types of networks, as is apparent to those skilled in the art in light of this disclosure.

The system 100 includes a host computer system 102. The host computer system 102 may include, for example, servers, personal computers, workstations, or other suitable computing devices. The host computer system 102 includes application software that programs the host computer system 102 to perform one or more functions according to the present invention. For example, application software resident on the host computer system 102 may program the host computer system 102 to receive and process prepaid wireless network access requests. In a specific embodiment, the host computer system 102 includes a loyalty program processor that tracks purchases made by customers and rewards them with points based on the purchases. The points may be redeemed for network access, among other things.

The host computer system 102 may include one or more of the aforementioned computing devices, as well as storage devices such as databases, disk drives, optical drives, and the like. The host computer system 102 may be fully located within a single facility or distributed geographically, in which case a network may be used to integrate the host computer system 102. Many other examples are possible and apparent to those skilled in the art in light of this disclosure. Thus, this example of a system 100 according to the present invention is not to be considered limiting.

The system 100 also includes a first communication network 104. The first network 104 may be the Internet, an intranet, a wide area network (WAN), a local area network (LAN), a virtual private network, a direct link, and combination of the foregoing, or the like. The network 104 may include both wired and wireless connections, including optical links. In some embodiments, the network 104 is a transaction settlement network, such as a credit card transaction processing network. In some embodiments, pre-paid wireless network access presentation instruments are activated through the first network. Through the network 104, merchant devices 106 communicate with the host computer system 102.

The merchant devices 106, typically located at merchant locations 107, may be any device capable of reading information from wireless network access presentation instruments and transmitting the information through a communication link, such as the network 104, to a processing system, such as the host computer system 102. The information may be comprised by a request for activating the presentation instrument. In some embodiments, the merchant devices 106 comprise a reader, such as a mag stripe reader, a smart chip reader, a bar code reader, an infrared reader, an RFID reader, or the like, in combination with a computing device. In some embodiments, the merchant devices 106 comprise point-of-sale devices such as those more fully described in co-pending, commonly assigned U.S. patent application Ser. No. 10/116,689, entitled “SYSTEMS AND METHODS FOR PERFORMING TRANSACTIONS AT A POINT-OF-SALE,” filed Apr. 3, 2002, by Earney Stoutenburg, et al., which is a continuation-in-part of U.S. Pat. No. 6,547,132, entitled “POINT OF SALE PAYMENT SYSTEM,” filed Aug. 9, 2000, by Randy J. Templeton, et al., which is a non-provisional of U.S. Prov. App. No. 60/147,899, entitled “INTEGRATED POINT OF SALE DEVICE,” filed Aug. 9, 1999 by Randy Templeton, et al, the entire disclosures of which are herein incorporated by reference for all purposes. In still other embodiments, the merchant devices 106 comprise specially-designed computing and reading devices for activating prepaid wireless network access presentation instruments. Merchant devices also may comprise kiosks, automated teller machines, vending machines, and the like. In some embodiments, the merchant device is an e-commerce server that provides the merchant with a virtual storefront (e.g., e-commerce web site). Those skilled in the art will recognize equivalent devices in light of this disclosure.

The merchant devices 106 may be located at any of a wide variety of merchant locations 107. By way of example and not limitation, “merchant locations” will be understood to include retail stores (e.g., book stores and the like), food and beverage vendors (e.g., coffee shops, fast food establishments, restaurants, and the like), public facilities (e.g., airports, libraries, office building, sports arenas, apartment complexes, hotels, airplanes, automobiles, cruise ships, malls, parks, and the like), and service providers (e.g., banks, health clubs, doctors' offices, and the like), among others. A “merchant location” also may be a web site or other virtual location.

The system 100 also includes a second network 108, which may be any of the aforementioned networks. The first network 104 and the second network 108 may be the same network, different networks, or portions of a larger network. The second network 108 provides a connection between the host computer system 102 and computing devices 109 at merchant locations 107. In a specific embodiment, the second network is a packet-based data network, such as the Internet. Wireless hubs 111 at merchant locations 107, allow customer computing devices 112 to access the second network 108. As those skilled in the art will appreciate the wireless hubs 111 may use and of a variety of wireless protocols, including 802.11b, 802.11a, 802.11g, 802.16, third generation 3G, or other appropriate communications protocol, which may be known by other common names such as Wireless Fidelity (WiFi), WiMAX, 3G, and the like.

The customer computing devices 112 may be, for example, laptop computers 112-1 or handheld computers 112-2. Many other examples are possible. The devices 112 may be equipped with network access cards that allow them to communicate with the network via the hub 111.

Attention is directed to FIG. 2, which illustrates an embodiment of prepaid wireless network access presentation instrument 200 according to an embodiment of the invention. It is to be understood that this embodiment of a presentation instrument is merely exemplary, and many other examples are possible. For example, a network access presentation instrument may be merely a number, and possibly a password and/or personal identification number, provided to a customer by a merchant. The number may be listed on a receipt or relayed verbally, for example. Other presentation instruments include RF fobs, “key chain” cards, and the like. In this specific embodiment, the presentation instrument 200 comprises what is commonly recognized as a “gift card” that is displayed at merchant locations attached to a card carrier. A customer desiring to obtain the service enabled by the presentation instrument 200 takes it to a cashier for payment and activation as will be described in more detail below.

The presentation instrument 200 may be embossed with an access number 202 and, in some embodiments, a logo 204, or brand. A back side 206 of the presentation instrument may include one or more information encoding regions, for example, a magnetic stripe 208 and/or a bar code 210. The information encoding regions may be read by a point-of-sale device (e.g., the merchant device 106 described above with respect to FIG. 1) and/or a reader associated with a customer computing device. In some embodiments, the presentation instrument includes a password area 212. The password may be a scratch-off region that does not reveal the password while the presentation instrument 200 is displayed for purchase.

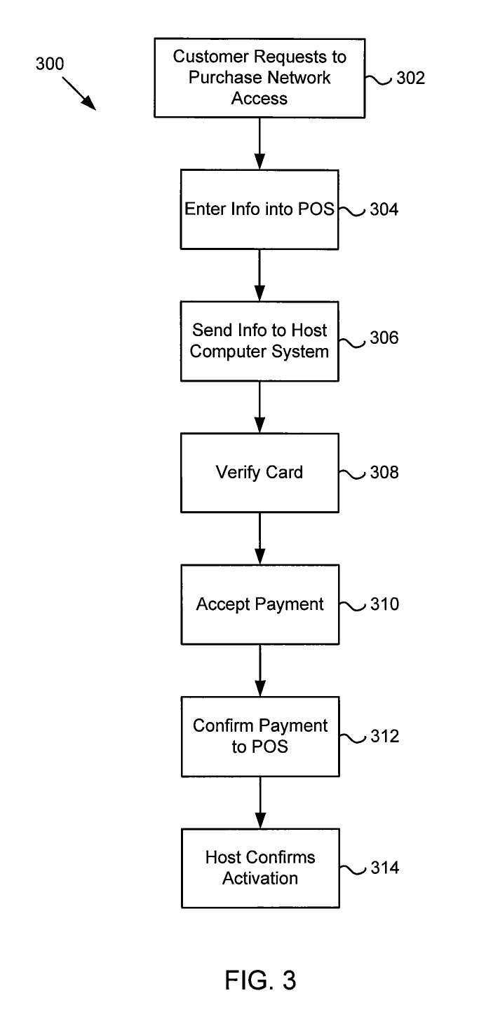

Attention is directed to FIG. 3, which illustrates a first method 300 of activating a prepaid wireless network access presentation instrument (“access card” or “card” for convenience) according to an embodiment of the invention. At block 302, a customer presents an access card to a merchant for purchase and activation. The card may be any type of instrument that represents the service to be provided. For example, the card may be a stored value card, a radio frequency identification (RFID) card, a smart chip card, a bar-coded card, and the like. The card may be used to access a specific wireless network or may be used to access several different networks.

In one embodiment, the “card” comprises a receipt that the customer receives at the conclusion of the transaction. The receipt has access information that the customer then may use to obtain network access. In some embodiments, the customer may be given the access information verbally or electronically, in which case no physical medium is involved. Thus, in some examples, presenting an access card to a merchant for purchase and activation comprises simply requesting such a transaction from the merchant without physically presenting anything to the merchant.

In another embodiment, presenting an access card to a merchant for purchase and activation comprises making a selection from an ecommerce merchant (e.g., placing the selection in an electronic shopping cart) and “checking out” via any of a number of well known systems for doing such. In yet another example, presenting an access card to a merchant for purchase and activation comprises requesting network access via a telephone operator or TRU. In another embodiment, presenting an access card to a merchant for purchase and activation comprises requesting a presentation instrument from an automated teller machine or kiosk. Other examples are possible.

At block 304, the merchant enters transaction information relating to the service requested by the customer into a POS. The transaction information may include an access number, which may be any number that uniquely identifies the service to be provided to this specific customer. The access number may be a unique number on a physical card (see, e.g., access number 202 of FIG. 2) that the customer presents to the merchant. In other embodiments, the transaction information comprises a product SKU# that represents the service the customer is requesting. This example will be described more fully immediately below.

In this specific example, a customer requests 40 hours of wireless network access from an attendant at a coffee shop. The attendant looks in a SKU# book and finds a listing of several services or promotions available for purchase by customers. In the “wireless network access” section, the attendant selects “40 hours” from a list of levels of access. Other levels may include, for example, 90 days, 12 years, 50 megabytes, and the like, each of which service or promotion may have a unique SKU#. The attendant then enters the unique SKU# for 40 hours of wireless network access into the POS. In other examples, the SKU# may represent the service (e.g., wireless network access) in which case, the POS may prompt the attendant to enter the level of service by selecting from a menu. Many other variations on this example are possible.

The information may be entered into the POS in any of a number of ways. If the “card” is a physical object, then the card may be interfaced to the POS in any of a number of ways. The card may be “swiped” through a reader, a bar code on the card may be scanned, the card may be placed in the vicinity of an RFID reader an infrared reader, and the like. In one embodiment, the merchant may use a bar code reader to scan a SKU# in a SKU# book such as in the specific example described in detail above.

In some embodiments, the transaction information entered by the merchant also includes payment information. For example, if a customer is purchasing a gift card for accessing a wireless network and is paying using a credit card, then the transaction may comprise first swiping the gift card, then swiping the customer's credit card. Those skilled in the art will recognize many variations on this example in light of the teachings herein.

Once the transaction information is entered into the POS, the POS sends the transaction information to a host computer system at block 306. If the transaction information contained a unique access number, then the host confirms the validity of the number. If the transaction information contained only a generic SKU#, then the host computer system may generate a unique access number for the customer. This may include both an access number and a key number (e.g., password) to be used by the customer in combination with the access number to obtain the service.

If the transaction information included a number requiring validation, the host computer returns verification of validity at block 308. At block 310, the merchant accepts payment for the service, then confirms to the POS that the payment was received at block 312. At block 314, the host computer confirms activation of the card and stores data that indicates the card as being active.

As stated previously, block 304, 306, 308, 312, and 314 may be reduced to a two-step process wherein the merchant swipes a card and identifies that the customer has tendered payment (e.g., in cash). Thereafter, the host computer returns confirmation of activation. Many other such examples are possible.

In some embodiments, confirming activation of the card may comprise sending a unique access number and password to the POS. The POS then may be used to print a receipt with the access information. In other embodiments, the POS may print an access card. The access card may be any of the previously mentioned access cards. In some embodiments, the activation process is completed in real time or near real time, thus allowing the customer to instantly access the service. In some embodiments, activation in real time means instantly (e.g., within about 5 seconds), near instantly, and/or with no pre-programmed or intentional delays.

If the customer is acquiring prepaid network access through an ecommerce merchant, catalog mail order operator, TRU, or the like, then the access information may be provided in any of a number of ways. In some examples, the merchant mails a physical card to the customer. In other embodiments, an operator or TRU provides the access information to the customer verbally. In still other embodiments, the access information is displayed on the customer's computer screen. Other examples are possible, and one does not necessarily preempt the other. For example, if the customer orders a card on line (e.g., via the Internet or World Wide Web), the access information may be displayed for the customer while the card is mailed.

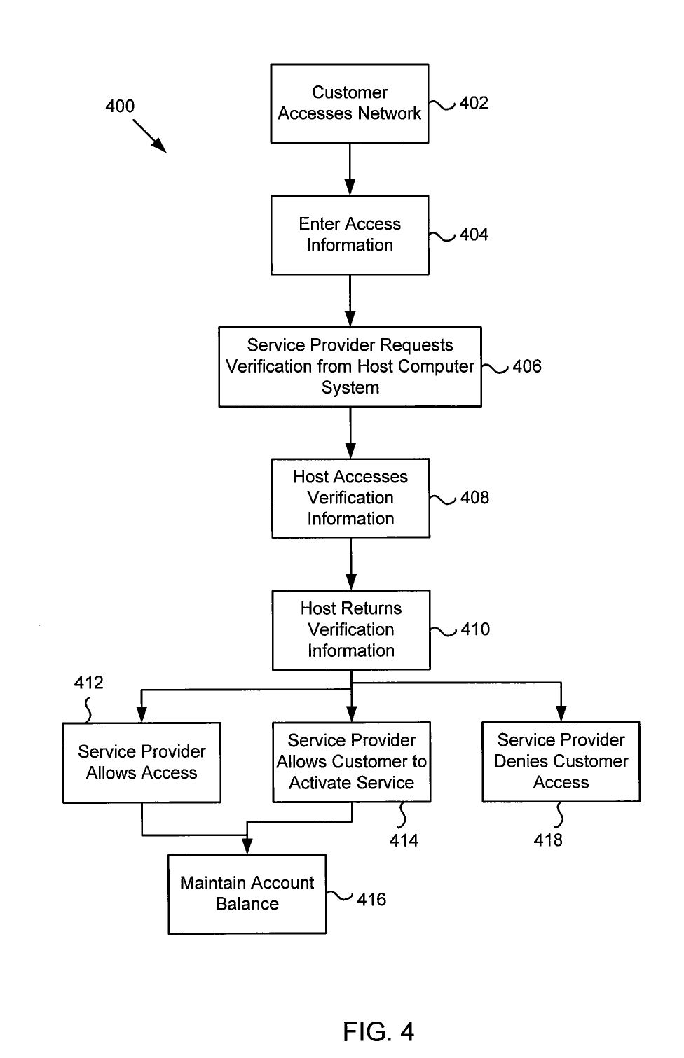

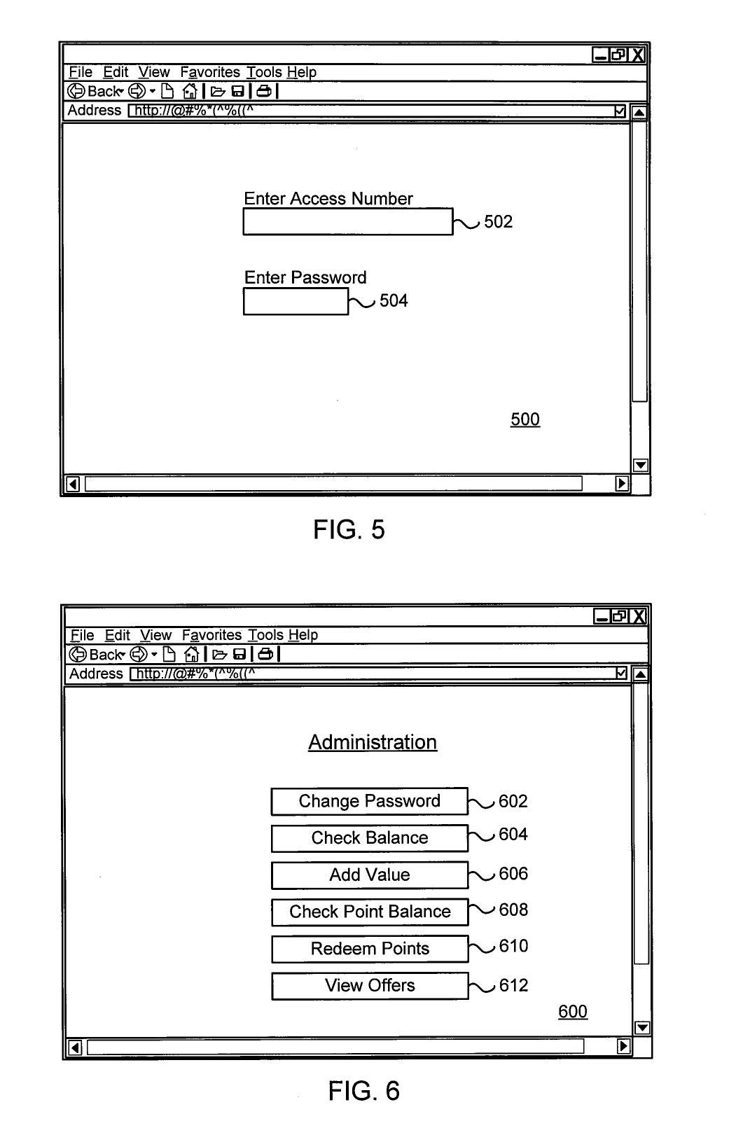

Having described a method of activating a prepaid wireless network access card, attention is directed to FIG. 4 in combination with FIGS. 5 and 6, which illustrate a method 400 of using a card to access a wireless network and exemplary display screens that may be used to enter necessary information and administer an account. At block 402, the customer requests access to the network using a computing device, such as a laptop computer, PDA, or the like. In a specific embodiment, this comprises using a wireless network access card of the computing device to detect a wireless network at a merchant location. In doing so, the customer may open a web browser on the computing device and have limited access to a service provider (e.g., an ISP). The service provider causes the network access display screen 500 of FIG. 5 to be displayed on the customer's computing device. The display screen serves as a gateway for the customer to the network.

At block 404, the customer enters access information. In some embodiments, this comprises entering information via a keypad into data areas on the display screen 500. For example, the customer may enter the access number 202 from the presentation instrument into the access number data field 502 and a key code (e.g., password) into the password data field 504. In other embodiments, this comprises using a reader (e.g., a magnetic stripe reader) to read information from a presentation instrument. In other examples, this comprises doing a combination of things such as reading information from the card followed by keying in additional access information, such as via a keypad. Other examples are possible.

At block 406, the service provider transmits the network access information to a host computer system 102. The network access information may comprise the unique identifier given to the customer, the access number on the card, and the like. The network access information also may include the customer's password, if used.

At block 408, the host computer system accesses its stored information to determine if the network access information is valid. The host computer system responds to the service provider at block 410. If the information is valid, the service provider allows the customer to access the network at block 412. If not, the service provider may allow the customer to obtain access at block 414 in previously-known ways. Otherwise, the service provider may simply deny the customer access at block 418.

Thereafter, the service provider and host computer system may cooperate to keep track of the customer's balance. This may be accomplished in a number of ways. For example, the customer may have purchased a finite number of megabytes of access, a finite number of minutes, and/or a finite access period. In either case, the service provider may send information to the host computer system that allows the host computer system to appropriately adjust the customer's balance. The host computer system then may use this information in the future to determine whether the customer should be given access to the network. Keeping track of the customer's declining balance is reflected as block 416 in FIG. 2.

Maintaining the customer's balance at block 216 may include keeping track of the customer's purchases using the presentation instrument. For example, if the customer makes purchases at the merchant location using the presentation instrument, the host computer system may credit the customer with loyalty points. Thereafter, the customer may redeem the points for other items, include additional network access.

In a specific embodiment relating to using a presentation instrument at a merchant location, the customer swipes the presentation instrument through a reader at the merchant location (or otherwise interfaces the presentation instrument with a reader or enters virtual presentation instrument into a reader) to initiate a session. The customer then accesses the network for a desired length of time. At the conclusion of the desired length of time, the customer ends the session by swiping the card. The host computer system or the merchant device calculates the session time and appropriately adjusts the customer's balance.

FIG. 6 illustrates an account maintenance display screen 600. The display screen 600 includes a number of buttons for accomplishing various functions. For example, using the display screen 600, the customer may change his password 602, check his network access account balance 604, add value to his presentation instrument 606, check his loyalty point balance 608, redeem points for network access or other items 610, and view offers from the merchant or service provider 612. Those skilled in the art will appreciate that this is but one example of how accounts may be administered in accordance with embodiments of the invention. For example, a customer may call an interactive voice response unit (IVR) or telephone response unit (TRU) to accomplish any or all of the aforementioned account maintenance functions.

In some cases, wireless access may be provided to the customer simply by using their stored value or prepaid account. Once the transaction is verified, the customer may have wireless access to the network, typically while the customer remains at the merchant location. A variety of transactions involving the stored value account may be performed in order to qualify the customer for free wireless access. For example, while in the store or merchant location, the customer may make a purchase using the account (referred to as a redemption), load value to the account (referred to as a reload), perform a balance inquiry, and the like in order to qualify for free access. Although the transaction may be performed at the merchant location where wireless access will be provided, the transaction could take place at other locations, such as on the Internet or at another store of the merchant.

A variety of rules may be used to determine whether the customer qualifies for free wireless access. For example, free access may be based on how frequently the account is used over a certain time, the total number of users, an amount of the transaction, and the like. Also, in some cases, the price of access could simply be reduced.

To gain access to the wireless network, the customer accesses a log-in screen using their personal computer. In some cases, the customer will be given a receipt when making the transaction at the point of sale. This receipt may include an access code that may be entered at the log-in screen. As an alternative, the customer's account number from the stored value card may be entered. In either case, the entered information is analyzed to see if the customer qualifies for free access.

The access rules can also vary. For example, the customer may have free access for only a certain time, such as 12 hours. This could be continuous or segmented over time. Or, it could be limited to a certain number of log-ins.

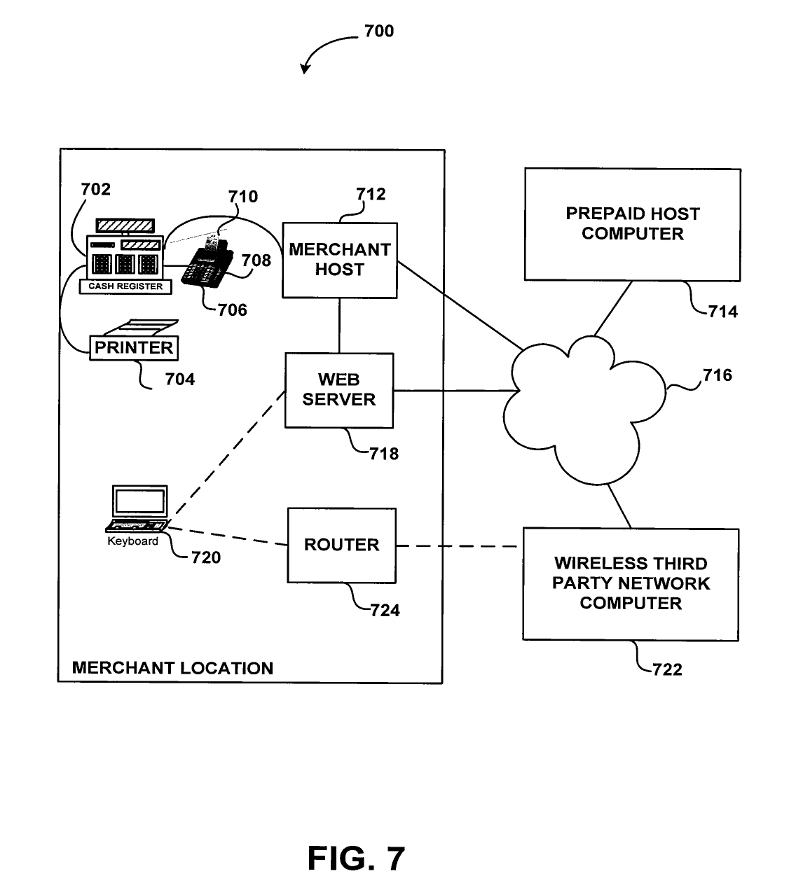

Also, the wireless network can be provided in-house or be maintained by a third party provider. A variety of equipment may be sued to establish the connection and to validate the user. One such system is illustrated in FIG. 7.

In FIG. 7, a merchant location 700, such as a retail store, is shown. At merchant location 700, various good and/or services are offered for sale. When ready to make a purchase, a customer will typically bring the selected item or items to a cash register 702 which may be typical of those in the art. Cash register 702 may include a cash till, check scanner, microprocessor, display screen, magstripe reader, RF reader, printer and the like. In some cases, some of the functions of cash register 702 may be performed by peripheral devices. For example, a separate printer 704 may be used to print documents, such as receipts. As another example, a POS device 706 may be coupled to cash register 702. POS device 706 may be similar to any of those described herein. Briefly, POS device 706 may have a mag stripe reader 708 for reading magnetic stripes on cards so that the account number may be obtained. Alternatively, POS device 706 could read smart cards, RF cards, bar codes and the like. In some cases, POS device 706 may have its own printer 710 for printing receipts.

When the account number is finally read, it is transmitted along with other transaction information (purchase price, reload amount, etc.) to a merchant host computer 712 which assists in completing the transaction. For example, merchant host 712 may communicate with a prepaid host computer 714 to validate the account number and to debit or credit the associated account as the case may be. A confirmation is then transmitted back to merchant host 712 and to cash register 702 and/or POS device 706 so that the transaction may be completed and a receipt printed.

When communicating with prepaid host 714, the data may be transmitted over a communication network 716 which may be any type of network, including those described herein. Also, although other pieces of equipment in FIG. 7 are shown to interact over network 716, it will be appreciated that this could be the same network or a separate network.

Merchant host 712 and prepaid host 714 may maintain a variety of information relating to each transaction. For example, such information can include the time of day, amount, store location, type of goods, and the like. Any of these items may be used to determine whether the customers may obtain free wireless access.

Access to a wireless network may be obtained through in-house equipment or through a third party provider. For in-house access, a web server 718 may be used. Web server 718 may be coupled to merchant host 712 and may have the ability to transmit web pages to wireless devices, such as the customer's personal computer 720. Also, web server 718 is coupled to network 716, such as the Internet, so that computer 720 may have wireless access to the Internet using web server 720. To do so, the customer may be provided with an access code after performing a transaction. This code is given after merchant host 712 and/or prepaid host 714 analyzes the transaction according to the rule set to ensure the transaction qualifies for wireless access. Using computer 720, the customer launches a web browser with the wireless radio turned on. The customer is prompted to enter the code. After entering the code, web server 718 communicates with merchant host 712 and/or prepaid host 714 to validate the code. If valid, the customer is granted wireless access to the Internet.

If a third party provider is used, the customer's computer may communicate with a wireless third part Internet computer 722. This may be facilitated through use of a router 724 which is located in merchant location 700. The third party network computer 722 may be any of the commercially available network computers offering wireless Internet access, such as those operated by Cingular, Verizon, T-Mobile and the like.

When the customer launches their browser to access the log-in website, the customer may be prompted to enter their account number. This may be obtained from their card. Upon entry and transmission to third party network computer 722, information from prepaid host 714 and/or merchant host 712 may be obtained to make sure the customer's account qualifies for free Internet access. If so, network access may be provided according to the rules dictating usage.

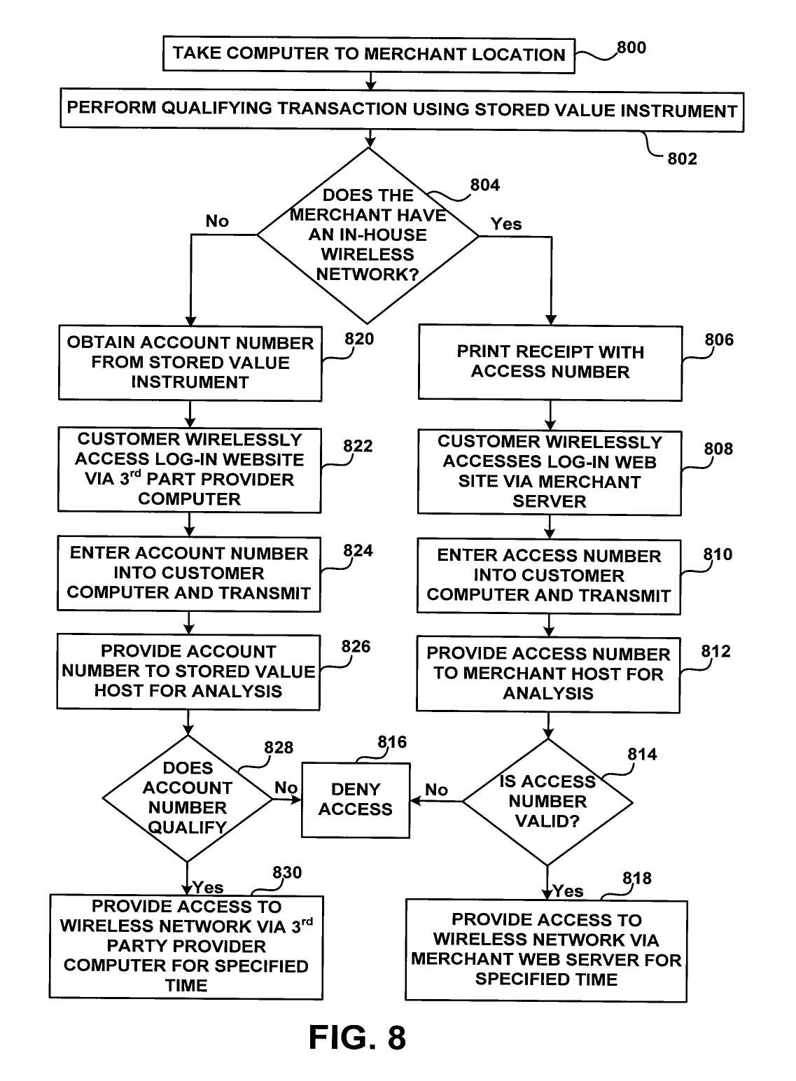

Referring now to FIG. 8, one method for providing network access to a wireless network will be described. Initially, the customer goes to a merchant location with his personal computer as shown in step 800. The personal computer may be a laptop or any other device having a wireless radio and browser software. At step 802, the customer performs a qualifying transaction using their stored value account. For example, the customer may purchase a book using their prepaid account. The process for proceeding with providing wireless access may depend on whether the merchant location has in-house capabilities to provide wireless network access or whether a merchant uses a third party provider (see step 804). If the merchant has in-house capabilities, the process proceeds to step 806 where the customer's receipt contains an access code. This code could be provided in other ways, such as in writing or verbally. At step 808, the customer wirelessly accesses a log-in site via the merchant's web server computer. The user is prompted to enter the access code after launching the web browser as shown in step 808. This web page is transmitted by the merchant's own web server. At step 810, the customer enters the access code and wirelessly transmits it to the web server.

To confirm that the access code is correct, the access code is provided to the merchant host (step 812) which performs an analysis to see if the account qualifies for free access. This may be done by checking to see if the access number is valid (see step 814). If not, the process proceeds to step 816 where wireless access is denied. If the access code is valid, access is provided to the wireless network via the merchant's web server for a specified time as shown in step 818.

If the merchant uses a third party provider for the wireless access, the process proceeds to step 820 where the customer obtains the account number from the prepaid card or other source. In step 822, the customer launches their browser to obtain a log-in screen from the third party provider host. The customer enters the account number and wirelessly transmits it to the third part host (step 824). The third party host then needs to verify that the account qualifies for free access. This information may be obtained from the stored value host or from the merchant (step 826). An analysis is performed to see if the account qualifies (step 828). If not, access is denied as shown in step 816. If it does qualify, access is provided to the wireless network via the third party provider (step 830) for a specified time.

Having described several embodiments, it will be recognized by those of skill in the art that various modifications, alternative constructions, and equivalents may be used without departing from the spirit of the invention. For example, those skilled in the art will realize that the teachings herein are not limited to wireless, packet-based networks. Additionally, a number of well known processes and elements have not been described in order to avoid unnecessarily obscuring the present invention. For example, those skilled in the art know how to arrange computing devices into a network and configure communication among them. Accordingly, the above description should not be taken as limiting the scope of the invention, which is defined in the following claims.

What is claimed is:

1. A method for providing connectivity to a wireless network, the method comprising:
at a merchant location, receiving at a point of sale device an account identifier that is associated with a stored value account of a customer;
transmitting the account identifier along with transaction data from the point of sale device to a financial network;
receiving at a communications device a request from the customer to access a wireless network while the customer is at the merchant location;
confirming whether the customer has performed a transaction involving the stored value account within a certain time period; and
providing wireless access to the wireless network if the customer has performed the transaction within the certain time period.

2. A method for providing connectivity to a wireless network, the method comprising:
receiving at a wireless communications device a request to access the wireless network, wherein the request includes an identifier, and wherein the request was made by a customer while at a merchant location;
evaluating the identifier to determine whether the customer has performed a transaction at the merchant location using a stored value account of the customer within a certain time period;
providing wireless access to the wireless network if the customer has performed the transaction within the certain time period.

3. A method as in claim 2, wherein the identifier is entered into a personal computing device of the customer, and wherein the personal computing device includes a wireless transceiver device to transmit the identifier to the wireless communications device.

4. A method as in claim 2, wherein the identifier comprises an account number that is associated with the stored value account.

5. A method as in claim 4, wherein the merchant location includes a local network having a merchant host computer system which includes a web server computer, wherein the web server computer comprises the wireless communications device, and wherein the web server computer receives transaction data from the merchant host computer system or a remote stored value host computer system, and wherein the transaction data is compared with the account number to determine whether the customer has performed the transaction within the certain time period.

6. A method as in claim 4, wherein the merchant location includes a router which communicates with a wireless network host computer system, wherein the wireless network host computer system comprises the wireless communications device, wherein the wireless network host computer system receives transaction data from a merchant host computer system or a remote stored value host computer system, and wherein the transaction data is compared with the account number to determine whether the customer has performed the transaction within the certain time period.

7. A method as in claim 2, wherein the identifier comprises a transaction number that was provided to the customer after performing a transaction involving the stored value account at the merchant location.

8. A method as in claim 5, wherein the merchant location includes a local network having a merchant host computer system which includes a web server computer and a point of sale device, wherein the web server computer comprises the wireless communications device, and wherein the web server computer receives the transaction number from the merchant host computer system, and wherein the transaction identifier from the customer is compared with the identifier from the merchant host computer system to determine whether the customer has performed the transaction within the certain time period.

9. A method as in claim 5, wherein the merchant location includes a router which communicates with a wireless network host computer system, wherein the wireless network host computer system comprises the wireless communications device, wherein the wireless network host computer system receives the transaction number from a merchant host computer system, and wherein the transaction identifier from the customer is compared with the identifier from the merchant host computer system to determine whether the customer has performed the transaction within the certain time period.

10. A method as in claim 5, wherein the transaction number is printed by a point of sale device.

11. A method as in claim 2, wherein the certain time is within the last twenty-four hours and further comprising providing the wireless access to the wireless network for a time that is in the range from about 2 hours to about 4 hours.

12. A method as in claim 2, wherein a connectivity time to the wireless network is based on a value of the transaction.

13. A method as in claim 2, wherein the transaction is selected from a group consisting of redemptions, reloads, activations and balance inquiries.

14. A system for providing access to a wireless network, the system comprising:
a wireless communications device that is configured to receive a request to provide access to the wireless network, wherein the request originates from a personal computing device of a customer who is present at a merchant location, wherein the request includes an identifier provided to the customer, and wherein the wireless communications device is configured to:
evaluate the identifier to determine whether the customer has performed a transaction at the merchant location using a stored value account of the customer within a certain time period; and provide wireless access to the wireless network if the customer has performed the transaction within the certain time period.

15. A system as in claim 12, further comprising a personal computing device of the customer having a wireless transceiver device to transmit the identifier to the wireless communications device.

16. A system as in claim 12, wherein the identifier comprises an account number that is associated with the stored value account.

17. A system as in claim 13, further comprising a local network disposed at the merchant location, wherein the local network comprises a merchant host computer system which includes a web server computer, wherein the web server computer comprises the wireless communications device.

18. A system as in claim 15, wherein the web server computer is configured to receive transaction data from the merchant host computer system, and wherein the web server computer is configured to compare the transaction data with the account number to determine whether the customer has performed the transaction within the certain time period.

19. A system as in claim 15, further comprising a remote stored value host computer system, wherein the web server computer is configured to receive transaction data from the stored value host computer system, and wherein the web server computer is configured to compare the transaction data with the account number to determine whether the customer has performed the transaction within the certain time period.

20. A system as in claim 13, wherein the merchant location includes a router which communicates with a wireless network host computer system, wherein the wireless network host computer system comprises the wireless communications device.

21. A system as in claim 18, wherein the wireless network host computer system is configured to receive transaction data from a merchant host computer system, and wherein the transaction data is compared with the account number to determine whether the customer has performed the transaction within the certain time period.

22. A system as in claim 18, wherein the wireless network host computer system configured to receive transaction data from a remote stored value host computer system, and wherein the transaction data is compared with the account number to determine whether the customer has performed the transaction within the certain time period.

23. A system as in claim 12, further comprising a point of sale device, and wherein the identifier comprises a transaction number that was provided to the customer by the point of sale device after performing a transaction involving the stored value account at the merchant location.

24. A system as in claim 21, wherein the merchant location includes a local network having a merchant host computer system which includes a web server computer and a point of sale device, wherein the web server computer comprises the wireless communications device, and wherein the web server computer is configured to receive the transaction number from the merchant host computer system, and wherein the transaction identifier from the customer is compared with the identifier from the merchant host computer system to determine whether the customer has performed the transaction within the certain time period.

25. A system as in claim 22, wherein the merchant location includes a router which communicates with a wireless network host computer system, wherein the wireless network host computer system comprises the wireless communications device, wherein the wireless network host computer system is configured to receive the transaction number from a merchant host computer system, and wherein the transaction identifier from the customer is compared with the identifier from the merchant host computer system to determine whether the customer has performed the transaction within the certain time period.
